(19) United States
(12) Patent Application Publication
(10) Pub. No.: US 2026/0047740 A1
(43) Pub. Date: Feb. 19, 2026

(54) WALL DEBRIS COLLECTION DEVICE

(71) Applicant: Janet Green, Hilliard, OH (US)

(72) Inventor: Janet Green, Hilliard, OH (US)

(21) Appl. No.: 18/729,278

(22) PCT Filed: May 21, 2024
(86) PCT No.: PCT/US2024/030301

§ 371 Date: Jul. 16, 2024

Related U.S. Application Data
(60) Provisional application No. 63/504,043, filed on May 24, 2023.

(51) Int. Cl. A47L 13/52; B23Q 11/00; E04G 21/30

(52) U.S. Cl. CPC A47L 13/52; B23Q 11/0053; B23Q 11/0067; E04G 21/30

(57) ABSTRACT

A device for collecting and maintaining debris from a wall (e.g., drywall) is described. In one example of the device of the present invention, two faces of the device each have a beveled edge, and are positioned at an obtuse angle with respect to one another. A corner apparatus may be positioned at a side edge of each face, and may permit the connection of the device to identical or similar devices. The device may be positioned on a floor adjacent to a bottom of a wall. In another example of the device of the present invention, two faces of the device each have a beveled edge, and are positioned at an acute angle with respect to one another. The device may be positioned on a wall above a floor.

### CROSS-REFERENCE TO RELATED APPLICATIONS

This application is a non-provisional patent application under the Patent Cooperation Treaty, based on and claiming priority to U.S. Provisional Application No. 63/504,043, filed on May 24, 2023, which is hereby incorporated by reference as if fully recited herein.

### TECHNICAL FIELD

Embodiments of the present disclosure relate to a device for collecting and maintaining debris from a wall, such as, for example, a drywall. In one example embodiment, faces of an exemplary device, each having a beveled edge, are positioned at an obtuse angle with respect to one another, and corner apparatuses run therebetween. Multiple devices may be connected to one another at the corner apparatuses thereof. The device may be positioned on a floor adjacent to a bottom of a wall, and may prevent debris from accumulating on the baseboards and/or floor proximate to the wall. In another example embodiment, faces of an exemplary device, each having a beveled edge, are positioned at an acute angle with respect to one another, and corner apparatuses run therebetween. The device may be positioned on a wall above a floor. The device may prevent debris from falling towards the floor and/or baseboards.

### BACKGROUND AND SUMMARY OF THE INVENTION

It is well known that drywall installation and maintenance practices such as, for example, putting up new drywall, patching existing drywall (e.g., after removing wallpaper), drilling in drywall, some combination thereof, or the like may generate a significant quantity of dust and/or other debris over a considerable area. As a specific, non-limiting example, the removal of wallpaper from drywall generally involves applying a significant amount of water to the wallpaper to soften adhesive between the wallpaper and the drywall, and as a result, liquid debris and pieces of wallpaper may fall onto the floor and/or baseboards below. In many instances, pieces of wallpaper may stick to the floor and/or baseboards, and may be very difficult to remove therefrom. As another non-limiting example, where a drill is used to drill a hole in drywall, a significant amount of solid debris may fall onto the floor and/or baseboards below.

Debris from drywall installation and maintenance practices may also accumulate in cracks/crevasses in the floor and/or between the floor and the wall, in addition to accumulating on the floor and/or baseboard surfaces. Traditionally, following drywall installation and/or maintenance, brooms and/or vacuum cleaners are used to remove debris from the floor surfaces, baseboard surfaces, and/or cracks/crevasses. Although brooms and vacuum cleaners are capable of removing some debris from floor surfaces, baseboard surfaces, and/or cracks/crevasses, brooms and vacuum cleaners may prove ineffective for removing all debris, and a tremendous amount of user effort may be required to remove debris, particularly with respect to debris in cracks/crevasses. Brooms and vacuum cleaners may also be ineffective for removing pieces of wallpaper, paint, and/or adhesive that have fallen on and stuck to a floor and/or baseboard (e.g., during paint or wallpaper application or removal).

Traditional debris removal techniques often address the issue of debris retroactively, and may fail to prevent debris from falling onto the floor and/or baseboards in the first place. Likewise, in the case of wallpaper removal, traditional debris removal techniques fail to address the issue of water from wallpaper removal ending up on the baseboards and/or the floor. The presence of water may cause damage to the baseboards and/or floor. Although drop cloths may be used to help retain some debris, vacuuming and/or shaking out drop cloths may be cumbersome and lead to the release of debris from the drop cloths on floors or other surfaces.

The aforementioned shortcomings speak to the need for a wall debris collection device capable of preventing debris and moisture from wall installation and maintenance practices from accumulating on baseboards and/or the floor. An exemplary embodiment of the present invention involves a device adapted to cause debris and/or moisture to accumulate on a surface of the device away from the floor, lower wall and/or baseboards, and configured to permit a user to remove debris and/or moisture directly from said surface.

According to the present invention in one aspect, an exemplary wall debris collection device comprises a first face having a beveled top edge and a second face having a beveled front edge. The first face and second face may be affixed to one another along a shared edge, wherein the shared edge may be positioned opposite of the respective beveled edge. Each face may also have a pair of side edges, each side edge extending from the shared edge to the beveled edge. The first and second faces may be positioned at 90 degrees or an obtuse angle with respect to one another.

A corner apparatus may extend substantially from a mid-portion of a side edge of the first face to a mid-portion of a side edge of the second face. The corner apparatus may be substantially triangular in shape. The corner apparatus may include a connection unit configured to connect the corner apparatus to a corner apparatus of an adjacent exemplary wall collection device, to, e.g., permit multiple wall debris collection devices to be connected to one another. The beveled top edge may permit the first face to rest flush against a lower wall, and may promote the retention of debris falling from the wall into the exemplary wall debris collection device. The beveled front edge may permit the second face to rest flush against a floor, and may permit debris falling away from the exemplary wall debris collection device to be readily swept into the device. An area of the second face proximate to the beveled front edge may be elevated with respect to a remainder of the second face to, e.g., promote the retention of debris in the device, although such is not required.

According to the present invention in another aspect, first and second faces of the device may be positioned at an acute angle with respect to one another, and the first face may be adapted to be attached to a wall above a baseboard and/or lower portion of the wall, such that the device may be suspended on the wall above a floor. The faces and corner apparatuses (e.g., triangular in shape) of the device may prevent debris (e.g., from spot drilling) from falling towards the floor. The beveled top edge may permit the first face to rest flush against the wall, and may promote the retention of debris falling from the wall into the exemplary wall debris collection device. An area of the second face proximate to a beveled front edge thereof may be elevated with respect to a remainder of the second face to, e.g., promote the retention of debris in the device, although such is not required.

Exemplary embodiments of the present invention may provide any number of different advantages. Exemplary embodiments may assist homeowners, home builders, maintenance and/or renovation professionals, painters, drywall installers, carpenters, electricians, interior designers, TV-mount installers, some combination thereof, or the like in preventing debris accumulation on baseboards and/or floors. As a specific, non-limiting example, a user may employ one or more exemplary wall debris collection devices to retain wall debris during a wall installation and/or maintenance practice, and may thereafter empty the debris from the one or more devices into a trash container.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a left-side elevational view of an exemplary wall debris collection device;

FIG. 2 illustrates a left-side elevational view of another exemplary wall debris collection device;

FIG. 3 illustrates a perspective view of the exemplary wall debris collection device of FIG. 1;

FIG. 4 illustrates a left-side elevational view of yet another exemplary wall debris collection device;

FIG. 5 illustrates a left-side elevational view of yet another exemplary wall debris collection device;

FIG. 6 illustrates a perspective view of the exemplary wall debris collection device of the FIG. 5 embodiment;

FIG. 7 illustrates a left-side elevational view of yet another exemplary wall debris collection device;

FIG. 8 illustrates a right-side perspective view of yet another exemplary wall debris collection device;

FIG. 9 illustrates another perspective view of the exemplary wall debris collection device of FIG. 8;

FIG. 10 illustrates a perspective view of a pair of exemplary wall debris collection devices connected to one another, in accordance with the FIG. 8 embodiment; and

FIG. 11 illustrates the pair of exemplary wall debris collection devices of FIG. 10 stacked with respect to one another.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

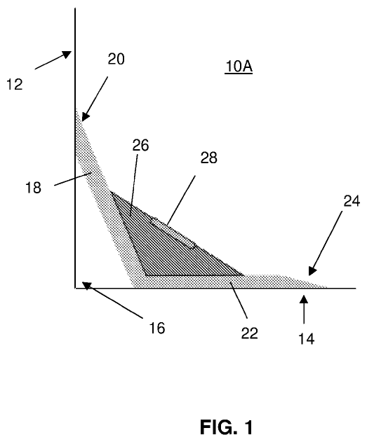

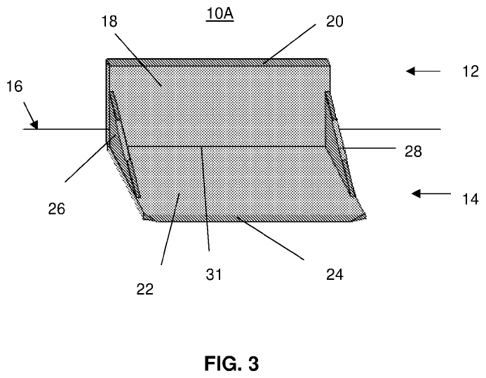

Referring now to FIGS. 1 and 3, an exemplary wall debris collection device 10A comprises a first face 18 and a second face 22. The first face 18 may include a beveled top edge 20, and the second face 22 may include a beveled front edge 24. The first face 18 and the second face 22 may be positioned at 90 degrees or an obtuse angle (e.g., as shown in FIG. 1) angle with respect to one another. As a non-limiting example, where the first face 18 and second face 22 are positioned at an obtuse angle with respect to one another, the first face 18 may extend away from where a wall 12 and floor 14 meet (e.g., corner 16) to provide an amount of space between the first face 18 and the wall 12 below the beveled top edge 20 of the first face 18. The obtuse angle may be approximately 110 degrees, although such is not required. The amount of space may, e.g., permit the device 10A to be readily positioned or repositioned along a bottom portion of a wall (e.g., 12) without a baseboard of the wall (often defining an area approximately 3-7 inches in height at the bottom of a wall) interfering with said positioning or repositioning. The amount of space may permit the beveled top edge 20 to rest flush against the wall 12 at or above the baseboard without the baseboard interfering with positioning of the beveled top edge 20. The specific length and slope of each beveled edge may be varied without departing from the scope of the present invention.

The beveled top edge 20, configured to rest flush with wall 12 (here, the beveled top edge 20 is bent to be positioned flat against the wall 12), may prevent debris from falling down the wall 12 onto the floor (e.g., 14), corner (e.g., 16) and/or baseboard (not shown) proximate to the wall 12. Rather, as debris falls onto device 10A, the debris may accumulate on the second face 22, slide down the first face 18 towards the second face 22, some combination thereof, or the like. Each of the first face 18 and the second face 22 may be approximately 8 inches in length, and between 15 and 18 inches in width, although such is not required. Variations may be made to the shape, sizes and/or material of exemplary device components without departing from the scope of the present invention. Accumulated debris on the device 10A may be removed from the device 10A by way of a broom, brush, or the like. Alternatively, or additionally, thin plastic (e.g., Saran wrap) may be positioned on the device 10A and then removed and discarded after debris collection. Alternatively, or additionally, the device 10A may be repositioned over a garbage container, and accumulated debris may be discarded into the garbage container.

A beveled front edge 24 of the second face 22 (here, the beveled front edge is a slanted surface extending from a main portion of the second face 22 to the floor 14) may, e.g., permit debris in the device 10A to be swept into a separate dustpan (e.g., by a broom or brush), debris accumulated in front of the device 10A to be swept into the device 10A and later discarded, some combination thereof, or the like. It will be apparent to one of ordinary skill in the art that there may be any number of different techniques available for removing and/or discarding accumulated debris from an exemplary device without departing from the scope of the present invention. The beveled front edge 24 may also reduce the risk of a user tripping over the device 10A. The device 10A may be temporarily secured to a wall by removable tape such as painter's tape, mounting putty, mounting strips, some combination thereof, or the like, although such is not necessarily required to secure the device 10A.

The first face 18 and second face 22 may be connected to one another along a shared edge 31 thereof. Each face 18, 22 may also have a pair of side edges, each side edge extending from the shared edge 31 to the beveled edge (20 or 24). A corner apparatus 26 may extend substantially from a mid-portion of a side edge of the first face 18 to a mid-portion of a side edge of the second face 22. The first face 18 and second face 22 may be rotated with respect to one another about the shared edge 31 (e.g., to permit adjustability of the angle between the two, such as for accommodating positioning of the device 10A proximate to any number of different baseboards), but such is not required.

As a specific, non-limiting example, hinges at the shared edge 31 may permit rotation of either face 18, 22. One or more removable corner apparatuses of any number of different shapes and/or sizes may be positioned on the device to achieve a desired angle between the first face 18 and the second face 22. The first face 18 may be rotated such that the beveled top edge 20 is positioned directly at a top edge of a baseboard (e.g., to permit debris collection by the device as a wall surface there above is sanded). The first face 18 may also be rotated such that the beveled top edge 20 is positioned well above the top edge of the baseboard (e.g., to permit debris collection by the device during wall drilling occurring well above the baseboard). As an alternative specific, non-limiting example, one or more corner apparatuses of a particular size and shape may be permanently affixed to the device, and the angle between the first face 18 and the second face 22 may be fixed. There may be any number of different techniques available for connecting the first face and the second face to one another.

In the embodiment of FIGS. 1 and 3, each corner apparatus 26 is substantially triangular in shape. The corner apparatus 26 may include a connection unit configured to connect the corner apparatus 26 to a corner apparatus of an adjacent exemplary wall collection device. Exemplary connection units may permit multiple wall debris collection devices to be connected to one another across a length of lower wall and floor (e.g., 14). In this particular embodiment, the connection unit is a hook surface 28 adapted to be received by an opposing hook surface of an adjacent device (to connect the devices to one another, at least temporarily). As a specific, non-limiting example, a number of exemplary devices (e.g., 10A) may be positioned at and connected to one another across an entire length of a lower wall to prevent the baseboard(s) and floor proximate thereto from accumulating any debris.

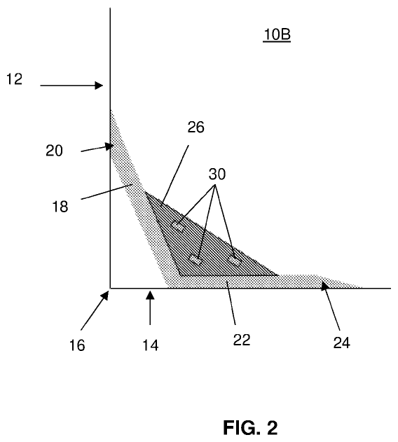

Referring to FIG. 2, another exemplary well debris collection device 10B having a first face 18 and beveled top edge 20, second face 22 and beveled front edge 24, and corner apparatus 26 is shown positioned proximate to a corner 16 of a wall 12 and floor 14. In this particular embodiment, a connection unit permitting multiple devices to be connected to one another comprises magnets 30 positioned at the surface of the corner apparatus 26. Said magnets 30 may attract opposing magnets or an opposing metallic surface of an adjacent device to connect multiple devices to one another, at least temporarily. There may be any number of different techniques available for connecting exemplary devices to one another without departing from the scope of the present invention, including by way of example and not limitation, hooks, clips, magnets, hook and loop fasteners, some combination thereof, or the like.

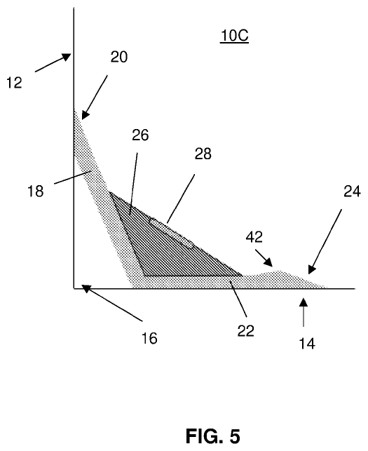

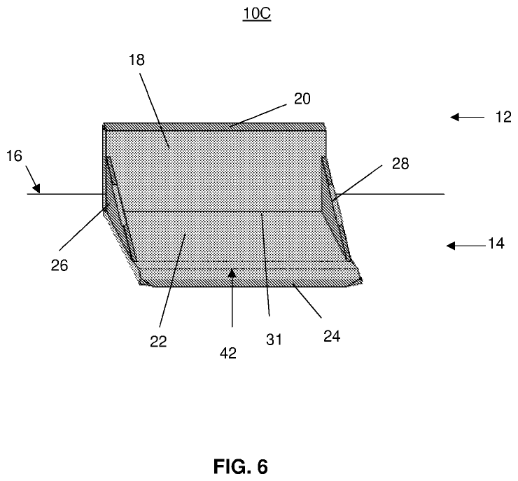

Referring to FIGS. 5-6, another exemplary wall debris collection device 10C having a first face 18 and beveled top edge 20, second face 22 and beveled front edge 24, corner apparatuses 26 (having hook surfaces 28), and shared edge 31 is shown positioned proximate to a corner 16 of a wall 12 and floor 14. In this particular embodiment, an area of the second face 22 proximate to the beveled front edge 24 thereof is elevated (elevated edge 42) with respect to the remainder of the second face 22. The elevated edge 42 may promote the retention of debris in the device by preventing debris from sliding and/or being blown past the beveled front edge 24. The elevated edge may comprise the same material (e.g., rigid plastic) as the first face 18 and second face 22, although such is not required.

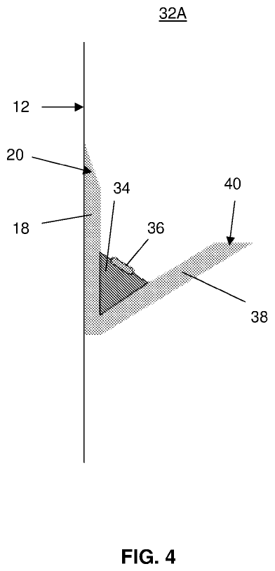

In FIG. 4, another exemplary wall debris collection device 32A having a first face 18 and beveled top edge 20, second face 38 and beveled front edge 40, and corner apparatus 34 (having hook surface 36) is shown positioned on a wall 12 above a floor (not shown). In this particular embodiment, the second face 38 is positioned at an acute angle with respect to the first face 18 resting flush against the wall 12. The acute angle may be approximately 80 degrees, although such is not required. The first face 18 may be approximately 3 inches long, and the second face 38 may be 5-6 inches long, although such is not required. The first face 18 may be secured to the wall above a lower portion and/or baseboard thereof by removable tape such as painter's tape, mounting putty, mounting strips, some combination thereof, or the like. The device 32A may be immobilized above the floor (not shown) to prevent debris (e.g., from sanding or spot drilling) from falling towards the floor. Debris may accumulate in the device 32A on or between the first face 18 and the second face 38. The beveled top edge 20 may permit the first face 18 to rest flush against the wall 12, and may cause any debris falling towards the first face 18 to be directed on or between the first face 18 and second face 28 (e.g., as opposed to falling behind the first face 18 and towards the floor).

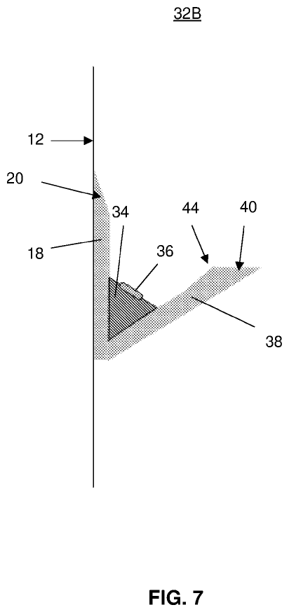

Now referring to FIG. 7, another exemplary wall debris collection device 32B having a first face 18 and beveled top edge 20, second face 38 (positioned at an acute angle with respect to the first face 18) and beveled front edge 40, and corner apparatus 34 (having hook surface 36) is shown positioned on a wall 12 above a floor (not shown). In this particular embodiment, an area of the second face 38 proximate to the beveled front edge 40 thereof is elevated (elevated edge 44) with respect to the remainder of the second face 38. The elevated edge 44 may promote the retention of debris in the device by preventing debris from sliding and/or being blown past the beveled front edge 40.

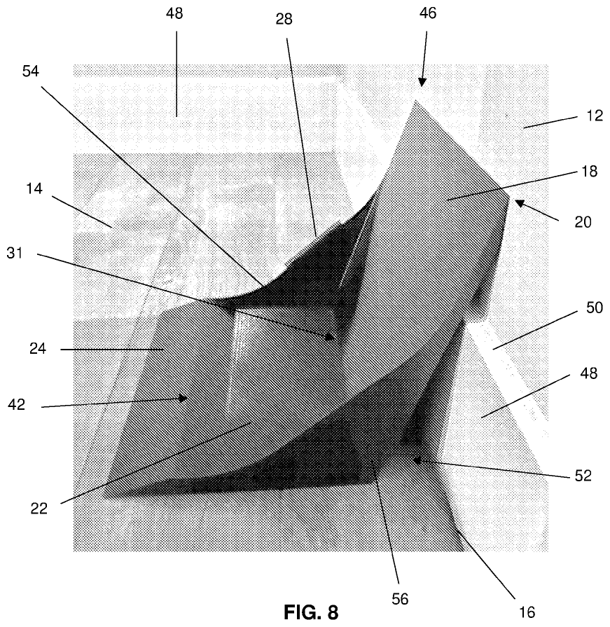

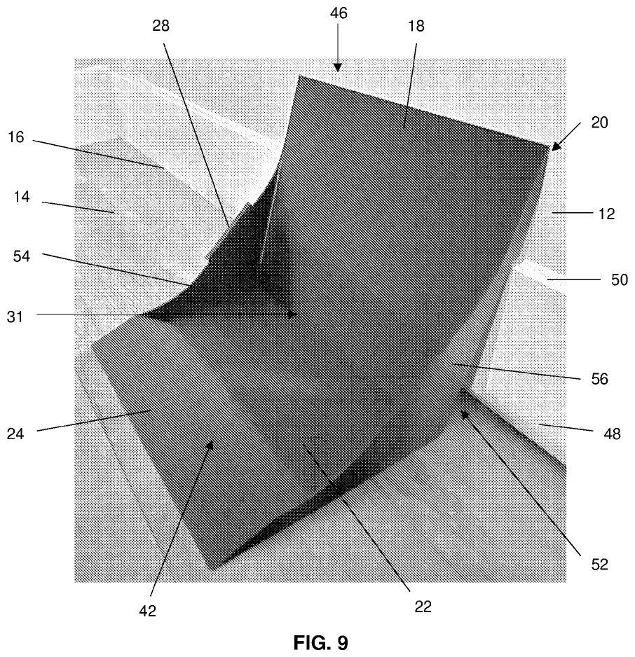

Referring now to FIGS. 8-11, an exemplary wall debris collection device 46 may be connected to and stacked over other like devices. In this particular embodiment, an exemplary device includes a first face 18 (having a beveled top edge 20) connected to (and positioned at an obtuse angle with respect to) a second face 22 (having a beveled front edge 24). Referring specifically to FIGS. 8-9, the device 46 may be configured to provide an amount of space 52 between a rear portion the device 46 and a baseboard 48 extending from a wall corner 16 to a top face 50 of the baseboard 48. The beveled top edge 20 of the device 46 may contact the wall 12 above the top face 50 of the baseboard 48 to, for example, prevent the baseboard 48 from interfering with positioning of the device 46, and to prevent debris from settling on the baseboard 48 or the floor 14.

Referring again to FIGS. 8-11, as debris falls onto the device 46, the debris may accumulate on the second face 22, slide down the first face 18 towards the second face 22, some combination thereof, or the like. Each of the first face 18 and the second face 22 may be about or greater than 12 inches in length, although such is not required. A beveled front edge 24 of the second face 22 may be positioned adjacent to an elevated edge 42. The first face 18 and second face 22 may be connected to one another along a shared edge 31.

In this particular embodiment, a first corner apparatus 54 of the device 46 is formed to and extends substantially from the first face 18 to the second face 22, and is formed thereto. The first corner apparatus 54 may be curved. Here, the first corner apparatus 54 includes a hook surface connection unit 28. Also, in this particular embodiment, a second corner apparatus 56 of the device 46 is formed to and extends substantially from the first face 19 to the second face 22, and is formed thereto. The second corner apparatus 56 may be curved. Here, the second corner apparatus 56 does not include a connection unit, but is adapted to be received by the connection unit 28 of an adjacently positioned device.

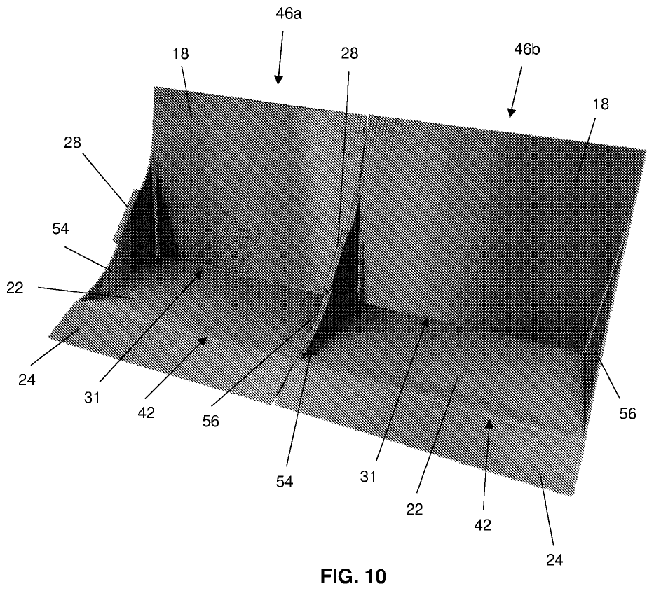

Referring specifically to FIG. 10, a first device 46a may be connected flush to a second device 46b by positioning an edge of the second corner apparatus 56 of the first device 46a in the hook surface connection unit 28 of the second device 46b. The hook surface connection unit 28 may comprise a curved structure extending along a portion of an edge of the first corner apparatus 54, the curved structure defining a receptacle sized to receive and immobilize the second corner apparatus 56 of an adjacent device (e.g., 46a). The second device 46b may be detached from the first device 46a by lifting the second device 46b up from the first device 46a.

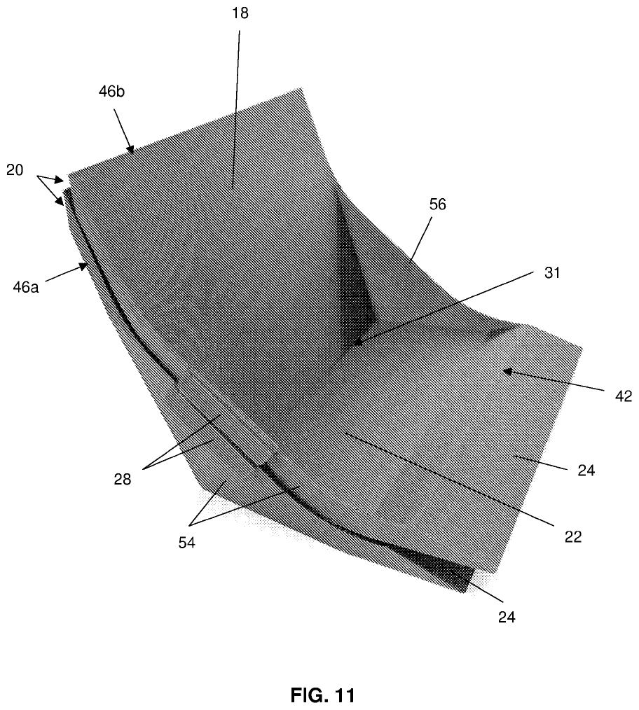

Referring now to FIG. 11, multiple exemplary devices (e.g., 46a-b) may be configured to be stacked on one another. A stack of any number of exemplary devices may be stored and/or transported together. For example, a box of several exemplary devices may be provided, and the several exemplary devices may be removed from the box at a wall maintenance location, and thereafter connected to one another across a length of wall baseboards. A bottom portion of the device (e.g., 46b) may be sized to receive another device (e.g., 46a) there below. For example, the bottom portion of the second device 46b may comprise a receptacle below the elevated edge 42 of the second device 46b for receiving the elevated edge 42 of the first device 46a.

It will be apparent to one of ordinary skill in the art that the particular size and/or shape of an exemplary embodiment may be varied. By way of example and not limitation, a smaller version of the device may be employed for spot drilling or other spot jobs. It will also be apparent to one of ordinary skill in the art that an exemplary device may be useful for other endeavors alternative or in addition to solid debris collection, including by way of example and not limitation, moisture collection (e.g., water droplets falling during wallpaper removal), paint collection (e.g., paint droplets falling during drywall painting), some combination thereof, or the like.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A wall debris collection device, comprising:
a first portion, comprising a continuous surface and a beveled top edge extending substantially a width thereof;
a second portion, comprising a continuous surface and a beveled front edge extending substantially a width thereof;
wherein the first portion is positioned at an angle with respect to the second portion;
wherein the first portion is configured to contact the second portion at an edge of the first portion opposite of the beveled top edge; and
wherein the beveled top edge is configured to contact a wall to prevent debris from falling behind the first portion.

2. The device of claim 1, wherein the beveled front edge is configured to contact a floor when the beveled top edge is in contact with the wall.

3. The device of claim 1, wherein the angle is equal to or less than 90 degrees.

4. The device of claim 2, wherein the angle is greater than 90 degrees.

5. The device of claim 2, wherein the beveled top edge is configured to contact the wall to cause the first portion to extend away from the wall to define a gap between the device and the wall.

6. The device of claim 4, wherein the angle is about 110 degrees.

7. The device of claim 1, wherein a corner apparatus is configured to be positioned at a side of the device, and extend from the first portion to the second portion.

8. The device of claim 7, wherein the corner apparatus comprises a connection unit configured to connect the corner apparatus to a corner apparatus of an adjacent device.

9. The device of claim 8, wherein the connection unit comprises a hook surface.

10. The device of claim 8, wherein the connection unit comprises one or more magnets.

11. The device of claim 7, wherein the corner apparatus is configured to be removably attached to the device.

12. The device of claim 7, wherein the corner apparatus is formed to the first and second portions.

13. The device of claim 9, wherein the hook surface defines a receptacle capable of receiving and securing a corner apparatus edge of an adjacent device.

14. The device of claim 1, further comprising an elevated edge proximate to the beveled front edge.

15. The device of claim 1, wherein the second portion is adapted to receive a second portion of another substantially similar device for stacking.

16. The device of claim 14, further comprising a receptacle positioned below the elevated edge, configured to receive an elevated edge of another substantially similar device for stacking.

17. A wall debris collection device, comprising:
a first portion, comprising a continuous surface and a beveled top edge extending substantially a width thereof;
a second portion, comprising a continuous surface;
a corner apparatus positioned at each side of the device, and extending from the first portion to the second portion;
wherein the first portion is positioned at an angle with respect to the second portion;
wherein the first portion is configured to contact the second portion at an edge of the first portion opposite of the beveled top edge; and
wherein the beveled top edge is configured to contact a wall to prevent debris from falling behind the first portion.

18. The device of claim 17, wherein each of the first and second portions are at least 12 inches in length.

19. A wall debris collection device, comprising:
a first portion, comprising a continuous surface and a beveled top edge extending substantially a width thereof;
a second portion, comprising a continuous surface and a beveled front edge extending substantially a width thereof;
a corner apparatus positioned at each side of the device, and extending from the first portion to the second portion;
an elevated edge proximate to the beveled front edge;
wherein at least one corner apparatus comprises a connection unit;
wherein the first portion is positioned at an angle with respect to the second portion;
wherein the first portion is configured to contact the second portion at an edge of the first portion opposite of the beveled top edge; and
wherein the beveled top edge is configured to contact a wall to prevent debris from falling behind the first portion.

20. The wall debris collection device of claim 19, wherein the connection unit comprises at least one selected from the group of a hook surface and one or more magnets.
